(19) United States
(12) Patent Application Publication
(10) Pub. No.: US 2026/0127383 A1
(43) Pub. Date: May 7, 2026

(54) SEARCH AND ANSWER GENERATION ENGINE FOR DATA SUMMARIZATION FROM MULTIPLE DATA SOURCES

(71) Applicant: PAYPAL, INC., San Jose, CA (US)

(72) Inventors: Siyuan Feng, Shanghai (CN); Wei Yuan, Shanghai (CN); Ciaran Maceochaidh, Glasnevin (IE)

(21) Appl. No.: 18/939,339

(22) Filed: Nov. 6, 2024

(51) Int. Cl. G06F 40/35; G06F 16/33

(52) U.S. Cl. CPC G06F 40/35; G06F 16/3347

(57) ABSTRACT

There are provided systems and methods for a search and answer generation engine for data summarization from multiple data sources. An online transaction processor or other service provider may provide computing services and platforms to entities, which may include live agent and self-service assistance features for answering users'questions. To provide more comprehensive searching and automated answer generation, the service provider may utilize an answer engine that may search multiple data sources in different data formats. Keywords may be extracted from a natural language question using an embedding LLM, and API calls to search features of each data source may be executed to retrieve relevant content. A summarization LLM may then concisely summarize the different content in different formats so that an answer may be provided. The user may then refine their question with further questions or requests, which may adjust the keywords and/or summarization.

### TECHNICAL FIELD

The present disclosure relates generally to generative artificial intelligence (AI) and models, and more specifically to cross-domain and data source search and answer generation engines using large language models (LLMs) and other generative AIs.

### BACKGROUND

Online service providers may offer various services to end users, merchants, and other entities. This may include providing computing services through different software applications, websites, platforms, and resources, such as those that may be involved with digital transaction processing. Further, the service provider may provide and/or facilitate the use of applications and websites for online payments, peer-to-peer (P2P) transfers, and/or other computing services to different entities including merchants or other entities and their corresponding users (e.g., code developers, employees, agents, etc.). However, use of these computing services may require implementation by new and foreign systems, which may require specific assistance. Users may encounter difficulties in finding the required resources and instructions, and personalized assistance or human agents is costly and may not be widely available to assist these entities. Further, data sources that may assist entities may be distributed across many different domains, platforms, and sources. Thus, it is desirable to automate labor-intensive processes for efficiently providing accurate answers to questions by users of the entities, and there is a need for an automated, intelligent, and efficient computing system and framework for search and answer generation across different domains, data formats, and sources.

### BRIEF DESCRIPTION OF THE DRAWINGS

FIG. 1 is a block diagram of a networked system suitable for implementing the processes described herein, according to an embodiment;

FIG. 2 is an exemplary system environment where a client device may make a request corresponding to a question to be answered by an intelligent answer generation engine of a service provider, according to an embodiment;

FIGS. 3A and 3B are exemplary user interfaces of an intelligent search and answer generation engine for multiple data sources, according to various embodiments;

FIG. 4 is a flowchart of an exemplary process for a search and answer generation engine for data summarization from multiple data sources, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for a search and answer generation engine for data summarization from multiple data sources. Systems suitable for practicing methods of the present disclosure are also provided.

A service provider, such as an online transaction processor, may provide computing services to users and/or their corresponding entities, which may include individual customers or other individuals, merchant customers of an online transaction processor, businesses and their representatives and/or employees, and the like. These computing services may include those associated with electronic transaction processing, P2P payments and transfers, cryptocurrency trading, and other computing services involved with payment processing. For these computing services, merchants may desire to utilize the services and/or incorporate the services with their computing platforms, while individual users may encounter issues that require assistance or instruction. This may require performance of specific tasks and operations, and therefore users may have questions and inquiries requiring assistance.

Conventionally, this type of assistance and instruction is provided through static data provided through instructional materials and/or other available or searchable information. The service provider may also utilize live agents and/or chatbots to provide responsive assistance to user outreach; however, these resources are limited in scope and/or availability. For example, frontline support may spend a significant time searching for relevant information to triage, investigate, and respond to issues across various platforms of a service provider. For example, a service provider may include internal platforms, systems, and/or applications that each have corresponding content and data, such as coding platforms and repositories, messaging and communication applications, historical cases, ticketing software, support tickets, and developer documents. While handling numerous cases, it is time-consuming and challenging for human agents to handle analytical tasks manually. As the volume of cases increases, the existing array of tools available to human agents may lack cohesive integration, hindering the optimal utilization of collective knowledge within the organization. Search and retrieval systems may be used in enterprise applications with generalized natural language processor (NLP) capabilities. These may provide assistance to document retrieval but are limited in scope. Further, such systems do not adequately handle data from multiple different sources and in multiple different formats.

As such, current search systems lead to delays in response times and reduced efficiency in resolving support issues. Another challenge encountered by these search systems may include fragmented information sources where multiple information sources may lead to disjointed and sometimes conflicting messaging to customers. Further, the search systems may have inefficient search functionality, resulting in delayed resolution and reduced teammate confidence in responses. “Tribal knowledge,” or informal knowledge not generally recorded in a formal training document, may cause general knowledge gaps, inconsistency, and risk of knowledge loss. Finally, the search systems may include knowledge content that is not AI consumable. This may cause hallucinations in LLMs and other AI models and systems with incorrect information being exposed to customers.

Users, including merchants, customers, and other entities or end users, affected by such issues may utilize computing services of a service provider, such as payment and transaction processing services of an online transaction processor. To utilize computing services of the service provider, the service provider (e.g., an online transaction processor, such as PAYPAL®) may require users and other entities requesting the services to have an account with the service provider. A user wishing to establish an account may first access the online service provider and request establishment of the account. When establishing accounts, login and/or corresponding authentication information with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The user may also be required to provide financial information, including payment card (e.g., credit/debit card) information, bank account information, gift card information, benefits/incentives, financial investments, cryptocurrency, and the like.

This information may be used to process transactions for items and/or services and provide assistance to users with these payment instruments and/or payment processing. The online payment provider may provide digital wallet services, which may offer financial services to send, store, and receive money, process financial instruments, and/or provide transaction histories. The application or website of the service provider, such as PAYPAL® or other online payment provider, may provide payments and other transaction processing services. The user may utilize the account with different computing services and/or to engage in one or more online or virtual interactions. During onboarding for accounts, usage of accounts and/or computing services, implementation and/or integration of computing services with external platforms of the users/entities, and the like, users may require assistance or have questions.

In this regard, in various embodiments, a service provider may provide an autonomous search and answer generation engine to address these challenges and enhance the efficiency of various search and answer systems and data summarizations. This may be done through an automated tool, agent, generative AI, and computing framework that may provide intelligent data summarization for data from multiple sources and data formats, which may be distributed across different platforms and/or databases, through a generative AI system that may implement LLMs and other generative AIs. As such, the framework may be capable of obtaining data in a more efficient and comprehensive manner, while summarizing the data from different formats to be understandable and coherent by users.

The service provider may provide an answer engine, such as an LLM and/or generative AI-based engine utilizing a retrieval augmented generation (RAG) model or bot (e.g., a machine learning (ML) or other AI model, engine, or processor) designed to augment the capabilities of frontline support teammates who interact with customers. This may use a combination of AI-suggested and human-selected/inputted keywords to improve the accuracy and relevance of content retrieval, thereby leveraging human experience and expertise along with AI's computational efficiency. A generative AI search and answer generation engine and system may include one or more LLMs, as well as other machine learning (ML) models, neural networks (NNs), or the like, to provide comprehensive multi-data source data summarization. These may include LLMs, generative pretrained transformers (GPTs) including ChatGPT™, and/or other generative AIs. Training of the LLM or other AI for the search and answer generation processes may be performed using data for the service provider and/or data sources, general knowledge, domain-specific knowledge, and/or third-party sources. These may include the linked data sources, which may correspond to different internal platforms of the service provider, such as an internal chat platform, a service ticketing platform, a code collaboration workspace platform, or computing service documentation. However, external and/or third-party data sources may also be linked and/or used for data searching and answer generation.

In order to reduce time-consuming tasks through enhanced data classification, agentic search, and context identification, the RAG model of the search system may be designed to augment the capabilities of LLMs, agents, and chatbots that interact with users when receiving questions or otherwise conversing with the users for assistance and answer generation. The engine and RAG model may utilize the AI-suggested and human-selected/inputted keywords for content retrieval through natural language understanding (NLU). An NLU processor may interpret the user input and queries to determine intent and relevant context. The answer engine may initially receive a query input, such as one or more questions or queries from an engineer/agent or directly from a merchant using natural language. The system may then analyze the query and determine keywords such as “account locked,” “reset link not working,” “password policy,” “two-factor authentication,” and the like. This may be done using the NLU processor and/or other NLP system, which may utilize an embedding LLM or a generative AI system. The embedding LLM may be configured to identify keywords through semantic analysis. For example, the embedding LLM may create vector representations of words, phrases, and the like in a vector space to capture their semantic meaning and determine keywords from intent and the like, as well as the AI-suggested and human-selected/inputted keywords.

Once the keywords are determined, the agent, merchant, or other user may select the relevant keywords from the suggestions to refine the search, or a search may be automatically performed based on a top-n keywords (e.g., as ranked based on occurrence, importance, relevance, similarity, etc.). To perform the search across multiple different data sources, an agentic search may be utilized, which may make individual calls to application programming interfaces (APIs) and search searches of the data sources. An agentic search may refer to a search that is performed using the keywords, as well as additional information from the question, user, or the like, such as a search that may be performed in the manner of a live agent with additional knowledge of the user and/or experience with the corresponding system, product, service, or the like. For example, each data source may have a corresponding search engine or system, which may provide access to stored and/or available data including articles, chats, online encyclopedia entries, training or educational materials, instructional content including audiovisual and/or text, and the like. The search and answer generation engine may include one or more APIs configured to execute these calls for data search and/or retrieval, and as such, may stitch together the individual data sources and platforms. A search may therefore be performed using the keywords and additional NLU information from the NLU processor, such as semantic analysis, intent, etc.

An agentic search may be used to actively search across multiple platforms (e.g., an internal chat platform, a service ticketing platform, a code collaboration workspace platform, computing service documentation, etc.) to gather relevant information by executing the calls to each platform for a search for content and other data associated with the keywords. The engine performs agentic searches across internal resources, and relevant data may be retrieved from these sources and temporarily stored for processing. For answer generation and synthesis, a summarization LLM of the generative AI may be used to synthesize information from the retrieved data. AI summarization may utilize the summarization LLM to synthesize information into concise answers specific to client intent. For example, an LLM may utilize a general and/or domain-specific knowledge base to summarize input information into a readable and understandable format for users, identifying main points, principles, instructions, or the like so that users can view information from multiple data sources in a single convenient interface and answer. As such, the summarization LLM may leverage the conversational and natural language AI models and algorithms to provide a conversational response to the user's question.

The synthesized answer may be presented to the user with links to the original sources for further exploration, which may allow the user to access and/or retrieve the content. Where the user may correspond to a customer or external user not authorized to access internal documents or content, redacted information may be provided, or authorization may be required, prior to presenting the user with links and/or allowing the user to access the data. Further, a follow-up question and/or refinement field or option may be provided where the user can ask follow-up questions to refine or expand the answer, which may lead to further searches using the initial keywords and/or adjustments to the keywords based on the follow-up questions. From these interactions, the engine learns from the inputs and feedback, continually improving the relevance and accuracy of the answers. Further, the engine may be linked to and/or trained on new resources and changing information to maintain relevancy of its answers.

With the engine, a knowledge management page may be used as an online webpage, interface, or other platform where users can upload, index, and manage knowledge documents for answer generation. These may be integrated with a vector database to store files, enabling quick retrieval through semantic search techniques. The knowledge engine may be used for searching of internal sources in a fast and efficient manner while summarizing data from multiple different sources and in different formats.

As such, the intelligent search and answer generation engine and system may provide a more efficient, accurate, and comprehensive tool for assisting users with identifying useful and relevant content through the use of LLMs and other generative AIs with additional AI components. The engine may therefore enable automating the search and data summarization tasks normally performed by live agents while uniting data from many different resources not conventionally available to such agents and search tools, allowing for a broader and more encompassing question-and-answer system for data retrieval. As such, searches for information and question answering may be completed in a more accurate and efficient manner, with less manual intervention and efforts, while identifying relevant content and summarizing in a coherent manner from many different data sources. The engine therefore enables coordinated communications between different system components to improve search and answer generation frameworks for computing systems and data of online service providers.

In this regard, the search and answer generation engine may improve cross-department efficiency by providing a unified tool that serves multiple departments, reducing the cost to serve and increasing servicing capacity. Further, the engine may improve the quality of generative responses, including those provided by LLMs and generative AIs, with comprehensive data retrieval, aggregation, and interpretation. Further, the answer engine may improve efficiency of knowledge sharing throughout a computing system by encouraging the use of institutional knowledge that makes the data more accessible. With increased accuracy and relevancy, as well as speed to resolution, the service provider may provide improved automated systems for customer request or assistance, which may provide better response times and/or first contact resolution.

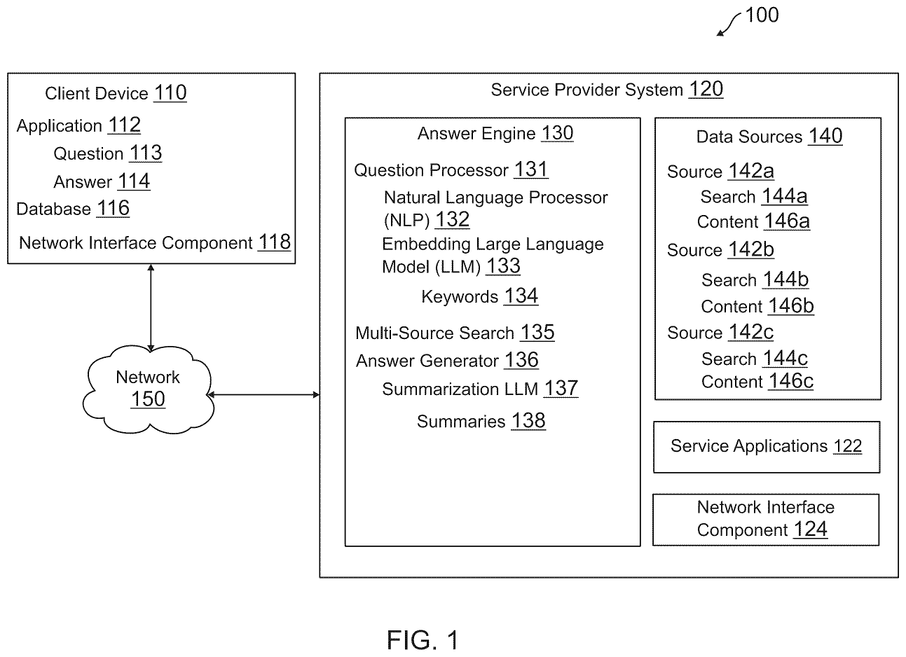

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., iOS, Android, Google OS, etc.), a merchant and/or point-of-sale (POS) device OS, or another suitable device and/or server-based OS. It can be appreciated that the devices and/or servers illustrated in FIG. 1 may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100 includes a client device 110 and a service provider system 120 in communication over a network 150. Client device 110 may be utilized by an internal agent or other internal user, such as an assistance agent or employee of an entity associated with service provider system 120, to receive communications over network 150. However, in other embodiments, client device 110 may instead be used by an external user and/or customer of service provider system 120, such as a merchant or individual user customer of an online transaction processor. Service provider system 120 may provide various data, operations, and other functions over network 140 to provide services to merchants, users, and their computing systems and devices. In this regard, client device 110 may be used to request an answer to a question in a conversational and/or summarized manner, where service provider system 120 may provide multiple data source search and data summarization for answer generation using one or more LLMs or other generative AIs, as discussed herein.

Client device 110 and service provider system 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Client device 110 may be implemented as a communication device of an investigator, agent, or other internal user associated with service provider system 120. Client device 110 may utilize appropriate hardware and software configured for wired and/or wireless communication with service provider system 120. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS ®), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 includes and/or is associated with an application 112, a database 116, and a network interface component 118, implementations of which are discussed further below. Application 112 may correspond to executable processes, procedures, and/or applications with associated hardware. In other embodiments, client device 110 may include additional or different modules having specialized hardware and/or software as required.

Application 112 may correspond to one or more processes to execute software modules and associated components of client device 110 to provide features, services, and other operations for a user for use with service provider system 120, such as to provide access to and service of computing services provided by service provider system 120 for assistance and/or question answering. Application 112 may correspond to specialized software utilized by a user of client device 110 to generate and transmit a question 113 requesting an answer 114 from service provider system 120 using an answer engine 130, which may utilize generative AIs for answer search, summarization, and generation. In some embodiments, question 113 may include a query, a request, a statement, or the like that is provided to elicit an answer from answer engine 130 in a conversational and/or summarized manner. This may include a request or query for a search, a request for assistance, instructional lookup, a request for specific information or content, or the like. Question 113 may also specify or otherwise identify a particular product, service, technology, or the like for which the user requires or is interested in obtaining assistance, instructions, usage, and the like. As such, question 113 may correspond to a query in natural language, such as a natural language question, which may require processing using a NLP for NLU of question 113. Application 112 may also be utilized to review and address responses to question 113, including answer 114 that may correspond to a summarization of content and other data searched for and retrieved from multiple data sources in multiple formats.

Application 112 may correspond to a general browser application configured to retrieve, present, and communicate information over the Internet (e.g., utilize resources on the World Wide Web) or a private network. For example, application 112 may provide a web browser, which may send and receive information over network 140, including retrieving website information, presenting the website information to the user, and/or communicating information to the website. However, in other examples, application 112 may include a dedicated application of service provider system 120 or other entity that may interact with service provider system 120 during question-and-answering requests, assistance sessions, and the like. Thus, application 112 may also correspond to different service applications that may provide automated assistance include chatbots and other assistance automations. When utilizing application 112 with service provider system 120, application 112 may transmit question 113 and receive responses to such prompt, question, or query, where question 113 may be transmitted to provide assistance, instructions, or other help and information.

Client device 110 includes other applications as may be desired to provide features to client device 110. For example, these other applications may include security applications for implementing client-side security features, programmatic client applications for interfacing with appropriate application programming interfaces (APIs) over network 150, or other types of applications. Other applications on client device 110 may also include email, texting, voice and IM applications that allow a user to send and receive emails, calls, texts, and other notifications through network 150. In various embodiments, the other applications may include those that may be utilized in the course of compliance investigations, system administration, maintenance, debugging, error resolution, engineering, and the like. The other applications may include device interface applications and other display modules that may receive input from the user and/or output information to the user. For example, client device 110 may contain software programs, executable by a processor, including a graphical user interface (GUI) configured to provide an interface to the user. The other applications may use devices of client device 110, such as display devices capable of displaying information to users and other output devices, including speakers.

Client device 110 may further include or have access to database 116, which may correspond to different types of data storage and components including cloud computing storage nodes, remote data stores and database systems, distributed database systems over network 140, and the like used to store various applications and data. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the user/client device 110 to service provider system 120.

Client device 110 includes at least one network interface component 118 adapted to communicate with service provider system 120 and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider system 120 may be maintained, for example, by an online service provider, which may provide computing services and operations via one or more digital platforms, applications, websites, and the like. Service provider system 120 may provide computing services to various entities, which may include computing services provider to internal and/or external users. As such, during the provision of services, assistance may be requested by customers and other users, which may be provided by live agents and/or an automated system utilizing answer engine 130 for search and answer generation. In one example, service provider system 120 may be provided by PAYPAL®, Inc. of San Jose, CA, USA. However, in other embodiments, service provider system 120 may be maintained by or include another type of service provider.

Service provider system 120 of FIG. 1 includes and/or is associated with service applications 122, a network interface component 124, answer engine 130, and data sources 140, implementations of which are discussed further below. Service applications 122, answer engine 130, and data sources 140 may correspond to executable processes, platforms, applications, and/or associated content and data with corresponding hardware. In other embodiments, service provider system 120 may include additional or different applications, platforms, and modules having corresponding hardware and/or software as required by their corresponding embodiments.

Answer engine 130 may correspond to one or more processes to execute modules and associated specialized hardware of service provider system 120 to provide a question processor 131, a multi-source search 135, and an answer generator 136 that may be utilized to provide searching and answer generating in response to questions by users including internal agents and employees and/or external customers associated with service provider system 120. In some embodiments, answer engine 130 may correspond to specialized hardware and/or software used by an internal agent, employee, chatbot, or other user and/or automation involved in aiding or assisting a user associated with client device 110, such as to provide the users with an answer to a question. However, in other embodiments, an external user, such as a customer, may also or instead access answer engine 130 directly to request answer generation using data from data sources 140.

For example, answer engine 130 may receive question 113 from client device 110 and process question 113 using question processor 131 to perform a search of data sources 140 using multi-source search 135 for content and other data used to generate answer 114 using answer generator 136. On receipt of input for question 113, answer engine 130 may utilize an NLP 132 to analyze text and speech for dialects, languages, slang, and/or grammatical irregularities and determine a context for question 113. The additional information and/or corrections made for question 113 by NLP 132 may be used by an embedding LLM 133 to generate keywords 134. For example, embedding LLM 133 may generate keywords 134 by representing the words, phrases, or other text (e.g., alphanumeric characters, symbols, emojis, etc.) in question 133 as one or more vectors in a vector space and determining semantic relationship based on this representation in a high-dimension space.

The embeddings of words and other text tokens (e.g., phrases, portions or truncations of words, etc.) in question 113 may correspond to encodings of semantic contexts and relationships that may be processed by a corresponding NN of embedding LLM 133 to determine keywords in question 113, such as those words of importance of content searching. Keywords 134 may therefore correspond to the important words or phrases that may be utilized to search for relevant content and other data from data sources 140. For example, for a search of “How do I setup and admin user for access privileges?”, keywords may include “setup,” “admin,” “user,” “access,” “privileges” or a combination thereof (e.g., “admin user” or “access privileges”). In some embodiments, all keywords from question 113 may be utilized for searching, or a top-n number of keywords, such as those meeting or exceeding a threshold keyword strength or similarity or question 113 and/or a preset number of keywords, may be selected for searching.

Using keywords 134, a multi-data source search may be executed of data sources 140 including sources 142a-c each corresponding to an individual and/or separate data platform (e.g., application, database, etc.) where data may be created, stored, and/or made accessible to other users and system components. As such, a multi-source search 135 may be utilized to execute this search of separate data platforms, which may utilize multiple APIs and/or API calls to interface with searches 144a-c for sources 142a-c, such as search engines or features of content 146a-c available from each platform. Multi-source search 135 may enable answer engine 130 to stitch together, call, and retrieve data from multiple data sources in multiple data formats, and therefore may be specifically configured to interface with the APIs of searches 144a-c for content searching and retrieval based on keywords 134. As such, multi-source search 135 may format and/or transform data for question 113 and/or keywords 134 as needed when calling each API for the corresponding search.

Using queries for each separate data source, multi-source search 135 may then retrieve data in different formats and/or styles for processing by answer generator 136. After retrieving search results, to further identify the relevant search results and content, question 113 may be converted to a vector and compared to vectors generated from the content, title of the content, description of the content, and/or keywords of the content from the search results. This allows for comparison of the vectors using a vector comparison function and determination of matches of search results that are sufficiently similar to question 113, such as based on a similarity threshold.

Answer generator 136 may include a summarization LLM 137 configured to summarize content including text, audiovisual media, and other data. In this regard, searches of content 146a-c by multi-source search 135 may retrieve different content or other data associated with keywords 134 for question 113. Using the search results, summarization LLM 137 may summarize the content in one or more of summaries 138, such as concise and abbreviated versions condensed from important information in the different content. In some embodiments, a top-n number of documents, files, or other data from the search results may be ranked and only that content may be used for summarization and output for answer 114. Summarization LLM 137 may utilize a general or domain-specific knowledge base with natural language training to create summaries 138 that provide a coherent and understandable summarization of the different content from the different sources and in their corresponding forms and/or data formats.

Summarization LLM 137 may correspond to an LLM or other generative AI having corresponding NNs, ML models, NLP capabilities, and the like that have been trained and configured for data summarization abilities. Summarization LLM 137 may correspond to an ML module using GPT, Bidirectional Encoder Representations from Transformers (BERT), A Robustly Optimized BERT Pretraining Approach (RoBERTa), or other language model that may be utilized for data summarization. For example, a data scientists and other model training teams may train LLMs for answer engine 130, including one or more LLMs, AI or ML models, NNs, conversational AIs, or the like. As such, embedding LLM 133 and summarization LLM 137 may include one or more NNs or other ML models, which may have trained layers based on training data and selected features or variables configured to for conversational dialogue, summarization, NLP and NLU, and/or other linguistic tasks.

For example, embedding LLM 133 and summarization LLM 137 may include deep neural networks (DNNs), MLs, generative AIs, or other AI models trained using training data, such as a knowledge base for NLP and NLU tasks including keyword identification and content summarization. When building embedding LLM 133 and summarization LLM 137, training data may be used for model training and configuring for these tasks. For example, with LLMs, training data may correspond to different corpora of documents and information, which may then allow the models to respond intelligently based on learning for such corpora. The algorithm and architecture for the embedding LLM 133 and summarization LLM 137 may correspond to DNNs, ML decision trees and/or clustering, conversational AIs, LLMs, generative AI, and other types of AI, ML, and/or NN architectures. The training data may be used to determine features, such as through feature extraction and feature selection using the input training data.

For example, DNN models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for ML models that attempt to classify and/or categorize the input data and provide corresponding language outputs.

Layers, branches, clusters, or the like of the DNNS of embedding LLM 133 and summarization LLM 137 may be trained by using training data associated with data records of interest, such as information associated with content, searching, and/or summarization tasks. In this regard, for training embedding LLM 133 and summarization LLM 137, corpora of documents associated with data sources 140 or a general knowledge base may be used. By providing training data, the nodes in the hidden layer may be trained (adjusted) such that an optimal output (e.g., a classification) is produced in the output layer based on the training data. By continuously providing different sets of training data and/or penalizing the DNNs when the outputs are incorrect, embedding LLM 133 and summarization LLM 137 (and specifically, the representations of the nodes in the hidden layer) may be trained (adjusted) to improve its performance.

After generation of summaries 138, answer 114 may be formulated and generated by answer engine 130, such as one of summaries 138 with corresponding information identifying the retrieved content from the multi-data source search. In some embodiments, answer 114 may further include the keywords used, which may be used for refinement of question 113 and/or the search, as well as an option, field, or other process to ask a further question and/or refine question 113 for more narrow searching and/or a more refined or specific answer. Answer 114 may include one of summaries 138 with links to the content used by summarization LLM 137 to generate the summary for answer 114. The links may be used by internal users when accessing internal documents, such as agents that may be assisting a customer. However, with external users that may request access to and/or may receive links to internal documents and content, those external users may require authorization to access such content.

Additionally, service provider system 120 includes or may access data sources 140 for data storage, search, and retrieval, as well as answer synthesis and summarization by answer engine 130 when providing answers to content and other data from multiple different ones of data sources 140 and/or in different data formats used by different ones of data sources 140. In this regard, data sources 140 may include sources 142a-c that may correspond to internal platforms and their corresponding applications, databases, and other computing system components. Sources 142a-c may be searchable using searches 144a-c for content 146a-c, such as by using a corresponding search engine and/or feature of sources 142a-c to identify corresponding data.

Each of sources 142a-c may be searchable in a corresponding data format and/or search engine/feature using searches 144a-c. For example, sources 142a-c may correspond to an internal chat platform, a service ticketing platform, a code collaboration workspace platform, or computing service documentation. Content 146a-c, as text data, audiovisual data, or a combination thereof, may be stored and may be required to be searched using a corresponding search engine and/or feature provided specifically for the content's platform. Answer engine 130 may be integrated with searches 144a-c so that searches 144a-c may be called, and searches executed by answer engine 130 for content 146a-c. Although data sources 140 are shown and described as being internal for service provider system 120, in other embodiments, one or more of sources 142a-c and/or other data sources may instead correspond to external platforms that act as a source of data that may be searchable by answer engine 130 for data retrieval, summarization, and question answering.

Data sources 140 may store various identifiers associated with client device 110. Data sources 140 may also store account data, including payment instruments, financial information, account balances, and authentication credentials, as well as transaction processing histories and data for processed transactions. Data sources 140 may include information associated with service applications 122 or another knowledge base and searchable data repository for question answering by answer engine 122. For example, data sources 140 may store articles, chats, online encyclopedia entries, training or educational materials, instructional content including audiovisual and/or text, and the like. Data sources 140 may include data from and/or be associated with an internal chat platform, a service ticketing platform, a code collaboration workspace platform, or computing service documentation. Although data sources 140 is shown as residing on service provider system 120 as a database system or data storage network, in other embodiments, other types of data storages and components may be used including cloud computing storage nodes, remote data stores and database systems, distributed database systems over network 140 and/or of a computing system associated with service provider system 120, and the like.

Service applications 122 may correspond to one or more processes to execute modules and associated specialized hardware of service provider system 120 to process a transaction and/or provide other computing services to users. For example, service applications 122 may be used to process payments and other services to one or more users, merchants, and/or other entities for transactions, where assistance in the use and/or integration of those services, applications, websites, data, and the like may be provided through answer engine 130 in an automated and comprehensive manner. In this regard, users, including merchants and other entities, as well as customers and individual users, may establish a digital account for engagement with the products and services of service provider system 120. For example, the account may be used to send and receive payments, including those payments that may be enabled through a website and/or application of users, merchants, and other transaction participants. A payment account may be accessed and/or used through a browser application and/or dedicated payment application executed by a device, such a payment and/or digital wallet application. Service applications 122 may process payments and may provide transaction histories to client device 110 and/or another user's device or account for transaction authorization, approval, or denial of the transaction for placement and/or release of the funds, including transfer of the funds between accounts based on compliance investigations.

In further embodiments, service applications 122 may provide different computing services to users and entities, including social networking, microblogging, media sharing, messaging, business and consumer platforms, etc. Use of, and/or integration of the computing services with an entities external and/or third-party platforms, applications, and systems, may require assistance, such as to answer a question regarding service usage or implementation in another application, or to receive instructions on use/implementation. As such, answer engine 130 may be configured to assist users, such as a user utilizing client device 110, with answering questions from multiple ones of data sources 140 and in a summarized and coherent manner for different data formations. In this regard, service applications 122 may be integrated with answer engine 130 for answering of questions during the use of service applications 122.

Service applications 122 as may provide additional features to service provider system 120. For example, service applications 122 may include security applications for implementing server-side security features, programmatic client applications for interfacing with appropriate APIs over network 150, or other types of applications. Service applications 122 may contain software programs, executable by a processor, including one or more GUIs and the like, configured to provide an interface to the user when accessing service provider system 120, where the user or other users may interact with the GUI to view and communicate information more easily. Service applications 122 may include additional connection and/or communication applications, which may be utilized to communicate information to over network 150.

Service provider system 120 may include at least one network interface component 124 adapted to communicate client device 110 and/or other devices and servers over network 150. In various embodiments, network interface component 124 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

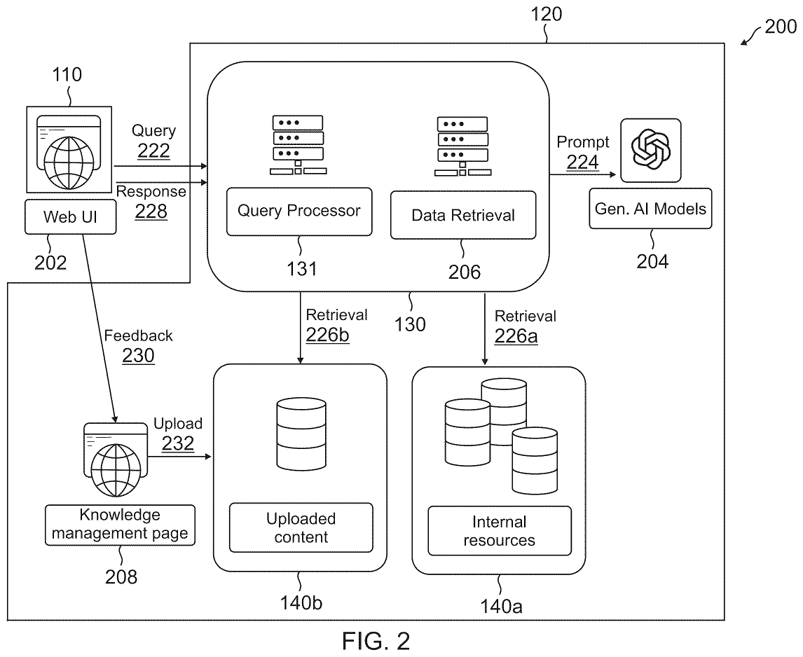

FIG. 2 is an exemplary system environment 200 where a client device may make a request corresponding to a question to be answered by an intelligent answer generation engine of a service provider, according to an embodiment. System environment 200 may include components of service provider system 120 that may be utilized by client device 110 when requesting answers to questions in natural language from multiple different data sources, as discussed in reference to system 100 of FIG. 1. In this regard, system environment 200 may correspond to a computing system of service provider server 120 when providing answer engine 130 for engagement with client device 110, where a web UI 202 may enable a user to transmit a query 222, such as a question, request, or statement in natural language that requires a corresponding answer or response, for content from the different data sources.

In system environment 200 of FIG. 2, an embodiment of answer engine 130 is shown where web UI 202 may provide access to and engagement with answer engine 130 on service provider server 120. In this regard, web UI 202 may be provided on client device 110, such as in application 120, and may correspond to a webpage and/or web application; however, in other embodiments, answer engine 130 may be accessed through different types of applications and UIs. Using web UI 202, a user, such as an agent or internal employee of the service provider or an external customer or user of the service provider, may submit query 222 for an answer. Query processor 131 may process query 222 using generative AI models 204, which may include a NLP, embedding LLM, summarization LLM, and/or other generative AIs that may be configured for search and answer generation as discussed herein.

In this regard, query processor 131 may create and/or configure (e.g., from templates) a prompt 224, which may correspond to an instruction to one or more of generative AI models 204 to perform a certain task and/or provide a response based on data for query 222, such as the question for query 222, contextual information for the user asking the question or associated with the question's answer (e.g., a question being asked on behalf of or for another person or entity), data on which a response is to be generated, and/or examples of responses. Generative AI models 204 may include a NLP that may assist in determining context for query 222, which may be based on semantics and other information. Additionally, the embedding LLM of generative AI models 204 may include a process to determine semantic relationships between words in query 222 for context determination and keyword extraction based on the embeddings, or vectors, generated from the words and phrases in query 222.

As such, prompt 224 may include a prompt to the embedding LLM or generative AI models 204 that may request keyword determination and extraction from query 222. The embedding LLM may extract the keywords by identifying the words and/or phrases of importance in query 222 based on an embedding analysis, such as by representing the words and/or phrases as embeddings or vectors and performing a semantic, contextual, and/or syntax analysis of query 222 for identification of important keywords within and/or associated with query 222. As such, a set of keywords may be returned to query processor 131 for query 222.

Answer generator 130 may then utilize data retrieval 206 to retrieve content, such as search results to searches, from different distinct data sources. Each distinct data source may correspond to a data platform, such as a computing service provided by an application, website, or the like, which may manage and/or store corresponding data. For example, data sources 140a-b may correspond to different internal platforms, such as a platform where internal resources may store data or another where uploaded content may be stored from user uploads. During retrievals 226a-b, searches of data sources 140a-b may be executed. In this regard, retrievals 226a-b may correspond to API calls made to APIs of search engines and/or search functions for data sources 140a-b, which may cause the corresponding search engine/function to search uploaded content, internal resources, or other data storages for content matching or associated with the keywords identified for query 222.

Once the content has been identified by data retrieval 206 from retrievals 226a-b, answer engine 130 may then perform a summarization so that an answer may be provided in response to query 222. For the summarization, generative AI models 204 may be utilized, such as a summarization LLM that may be configured for linguistic processes including text and/or other data summarization. The summarization LLM may be trained on a knowledge base that may be general or domain-specific to reduce input text or other data to a condensed size or length based on important and/or recurring information, features, and/or themes. In this regard, the summarization LLM of generative AI models 204 may be trained to identify recurring information between the content from the search results of retrievals 226a-b, and summarize that information based on importance and in a natural language manner or understanding. As such, a coherent and concise statement of the content may be generated. This may further be done through one or more prompts having instructions to the summarization LLM to summarize the content, where the prompts may include or identify the content, samples of answers, and the like.

As such, answer engine 130 may provide a response 228 including the answer having the summary of the content from the summarization LLM. Response 228 may be provided to client device 110 and output or displayed in web UI 202. Further, the answer in response 228 may include links to and/or identification of the content from the search results and/or utilized when generating the answer. For example, links and/or citations may be provided at the end of and/or in association with corresponding portions of the answer so that the user viewing web UI 202 may access and view additional information for the answer. The answer may be provided in natural language and/or may extract and provide portions of the underlying content for review in response 228.

Web UI 202 may provide a UI field or option for the user to ask follow-up questions and/or refine the initial question and/or keywords. As such, refinement of query 222 may be provided back to answer engine 130, which may generate new and/or additional keywords for searching using data retrieval 206 and content summarization using generative AI models 204, as well as updating of the previous keywords and/or changes to the content from the initial search result. Further, the user may be capable of providing feedback 230 via web UI 202 to a knowledge management page 208, which may allow the user to upload content and/or specify particular information that may be of assistance with answering their question and/or providing additional information and knowledge for other question answering. As such, feedback 232 may be used to further build a base of knowledge for answering different questions by answer engine 130, which may be managed through knowledge management page 208. Feedback 230 may be stored to data source 140b, such as an uploaded content data storage, via an upload 232.

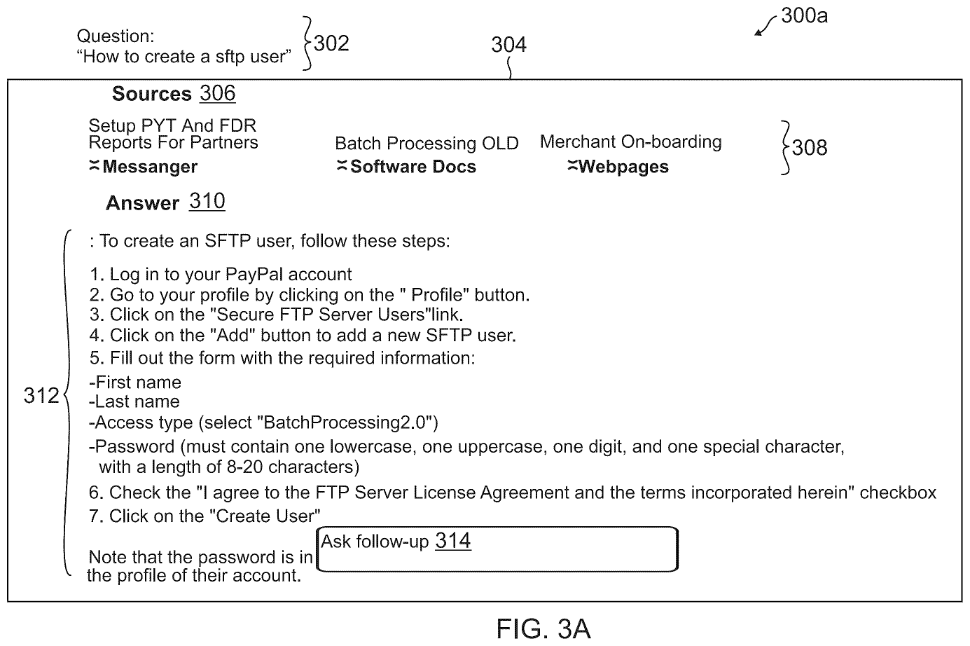

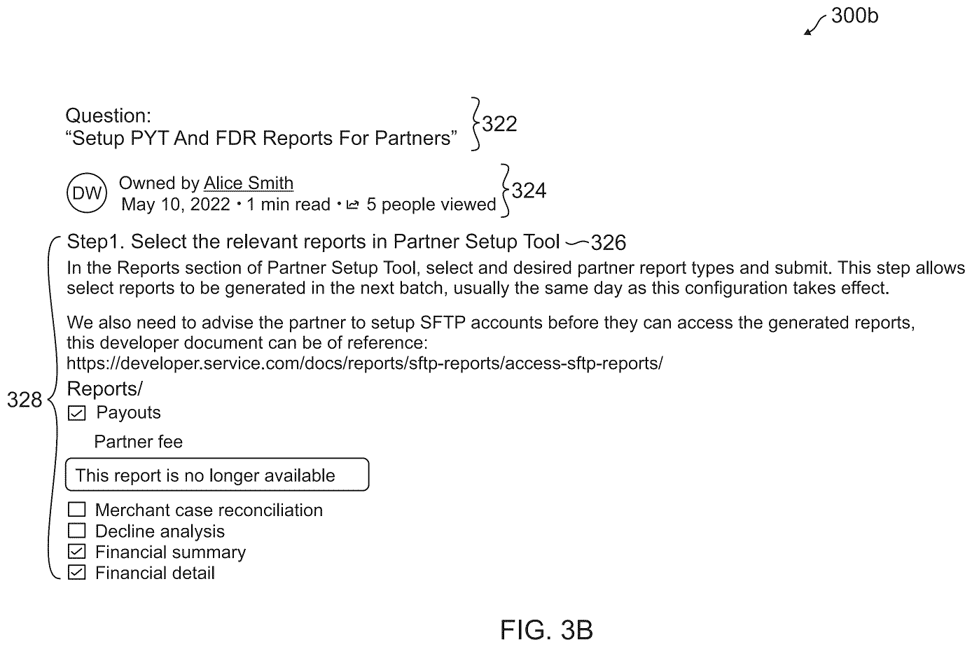

FIGS. 3A and 3B are exemplary user interfaces (UIs) 300a and 300b of an intelligent search and answer generation engine for multiple data sources, according to various embodiments. UIs 300a and 300b include information displayed on a computing device in response to accessing answer engine 130 and asking a question in natural language for an answer, or otherwise querying answer engine 130. As such, UIs 300a and 300b may be displayed via application 112 on client device 110 in system 100 of FIG. 1, based on engagement with answer engine 130 of service provider system 120. UIs 300a and 300b may include output information from a multi-data source search and answer generation, which may use generative AIs for keyword extraction and answer synthesis.

Referring now to UI 300a in FIG. 3A, a question 302 may initially be asked to answer engine 130 for an answer, such as “how to create a sftp user?” or similar question, statement, request, or the like in natural language. Secure file transfer protocol (SFTP) may correspond to a network protocol for that may provide secure processes for accessing, transferring, and managing data files that may contain sensitive data. In this regard, creating an SFTP user may be a requirement for certain customer entities and/or users of a service provider when utilizing the computing services of the service provider (e.g., account services including creating multiple accounts for different employees and tasks) and/or implementing the service provider's computing services with a platform of that customer. As such, question 302 may require an answer that relies on content and other data from different internal platforms of the service provider, such as an internal chat platform where internal code developers may discuss account and login privileges and/or access rights, a service ticketing platform that may have assisted other customers, a code collaboration workspace platform where code development documents and specifications may be stored or written, or computing service documentation for the computing services and their instructional information.

After entry of question 302, answer engine 130 may generate an answer 304 using a generative AI system. The generative AI system may provide different models for different inferencing and/or generative tasks, such as a NLP to understand the natural language input of question 302 for content and/or context of question 302, an embedding LLM to extract keywords from embeddings and embedding analysis, and/or a summarization LLM to summarize the text and other data in content retrieved from multiple data sources. As previously discussed, answer engine 130 may search and retrieve data from multiple data sources in multiple data formats, which may be identified using the keywords determined from question 302. In this regard, answer 304 may include data from sources 306 that is summarized in an answer text 310.

Sources 306 may be cited in answer 304 as citations with links 308 allowing the user viewing UI 300a to view and access the content that has been summarized in answer text 310. As such, the user may be capable of accessing the content directly in order to further obtain information that may be responsive to question 302. Answer engine 130 may provide links 308 to link to the content directly, which may allow internal users and/or those users with access and authorization for the content to view the content. However, with external users and/or users that are not authorized and/or authenticated, links 308 may not be provided or may require an authorization and/or authentication process prior to allow the user to access the data.

Answer text 310 is shown with a summarization of content from sources 306. Answer text 310 includes steps 312 that provide a step-by-step guidance in creating an SFTP user to answer question 302. In some embodiments, answer text 310 may be directly taken from one of sources 306, such as when a summarization LLM determines that the information in steps 312 is directly relevant to the answer. However, steps 312 may also be synthesized and provide a natural language response from information taken from distinct data sources in different data formats. In some embodiments, the portions directly relying on certain ones of sources 306 and corresponding content or other data may be directly cited by citations of sources 306 and/or links 308 so that a user viewing answer text 310 may understand what portions of the content has been summarized in generating answer text 310. Further with steps 312, a follow-up question field 314 may be provided in the event that a further question may be required to narrow or refine question 302 and obtain the desired information. As such, follow-up question field 314 may establish new keywords or change existing keywords (e.g., by reranking, removing, etc.), or may provide a further search of additional information for display with answer text 310.

Referring now to UI 300b in FIG. 3B, a similar display or output of information in response to a question 322 is shown, where instead of providing sources 306 and links 308 directly, a step-by-step walkthrough and instructional series may be provided with embedded citations to documents and other content of relevance to the instructions. In this regard, question 322 requests information for setting up reports for partners, which may be answered by a developer document 324 from a data source. Content and other data in developer document 324 may be parsed and extracted by a summarization LLM so that an answer may be generated and provided via UI 300b. As such, developer document 324 may be summarized instead through an instructional walkthrough having steps that may be advanced during review by a user.

For example, a first step 326 may be displayed in UI 300b, which provides an initial step to take in the series of steps that may be used to answer questions 322 and provide the relevant information. First step 326 may include instructions 328 having text and may also include an embedding link to developer document 324 and/or other content, as well as interactable elements for further data presentation. As such, a user utilizing instructions 328 may interact with data presented in UI 300b to receive further information relevant to question 322 and/or that may assist the user in resolving their question, need for assistance, and/or help request.

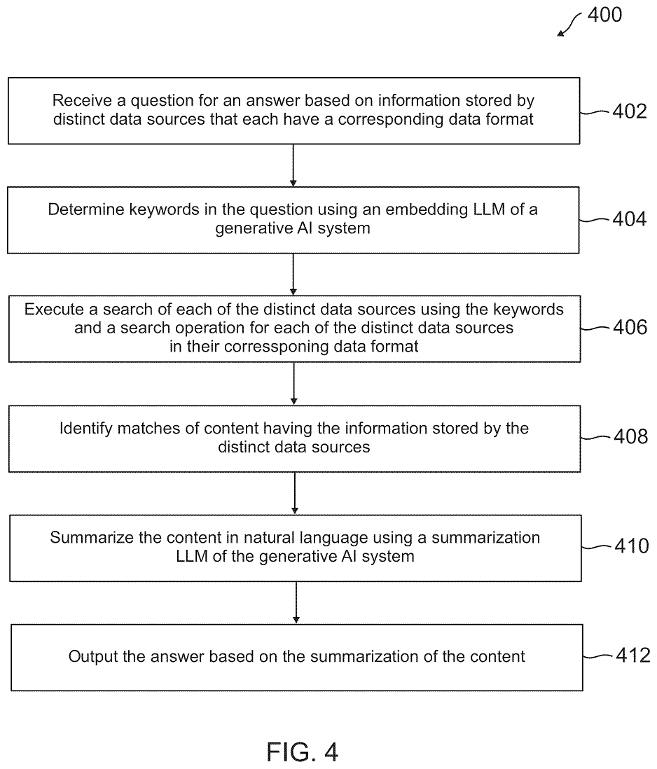

FIG. 4 is a flowchart 400 of an exemplary process for a search and answer generation engine for data summarization from multiple data sources, according to an embodiment. Note that one or more steps, processes, and methods described herein of flowchart 400 may be omitted, performed in a different sequence, or combined as desired or appropriate.

At step 402 of flowchart 400, a question for an answer based on information stored by distinct data sources that each have a corresponding data format is received. For example, answer engine 130 of service provider system 120 may receive question 113 from client device 110. Question 113 may correspond to a query requesting some information or a search to be conducted, which may provide assistance for a user with one or more of the products or services provided by service provider system 120. As such, the question may require and/or be requested to be answered using data from multiple disparate data sources and their corresponding platforms (e.g., applications, databases, etc.), such as data sources 140 of service provider system 120 having sources 142a-c. In this regard, by searching content 146a-c from sources 142a-c to provide answer 114 to question 113, a more comprehensive and complete answer may be provided.

At step 404, keywords in the question using an embedding LLM of a generative AI system are determined. After receiving question 113, question processor 131 may parse the words, text, and other content of question 113, including any audiovisual content, graphical images including emojis and/or animations, and the like, using NLP 132 to determine any relevant context and/or additional information used to contextualize question 113 for better NLU and keyword extraction. Embedding LLM 133 may utilize embeddings, such as vectors or other mathematical representations in a vector space, to identify keywords of importance in question 113. The embeddings may be compared, processed, and analyzed by embedding LLM 133 to determine keywords 134 including a set, such as all or a top-n number, of keywords 134 that are of importance and/or may be used to perform an agentic and contextual search of data sources 140. Embedding generation and keyword determination by embedding LLM 133 may be performed by prompting embedding LLM 133 using question 113, as well as additional contextual information, with an instruction to create embeddings and perform keyword determination and/or extraction using such embeddings.

At step 406, a search of each of the distinct data sources is executed using the keywords and a search operation for each of the distinct data sources in their corresponding data format. Multi-source search 135 may utilize keywords 134 to search sources 142a-c from data sources 140. Searches by multi-source search 135 may include calling the search engines or features of searches 144a-c and requesting that searches 144a-c perform searches of content 146a-c. Searches 144a-c may return matching content and other data from content 146a-c to multi-source search 135. The returned search results may therefore provide content that answers or is relevant to question 113.

At step 408, matches of content having the information stored by the distinct data sources are identified. In some embodiments, the matches of content may correspond to the search results from searches 144a-c, which may be ranked and/or organized by the search engines and/or features of searches 144a-c before being returned to multi-source search 135. As such, the content returned may correspond to the matches to keywords 134. However, in order to further rank, organize, and/or identify whether the returned content is actually responsive to question 113, multi-source search 135 may further vectorize question 113 by converting the text of question 113 to a vector and comparing that vector to vectors generated for the title, description, file name, content, or the like from each of the search result's content. As a result, the vectors may be compared using a vector comparison algorithm or process, such as cosine similarity, Euclidean distance, or the like, which may then be used to determine whether each returned content has a threshold similarity to question 113.

At step 410, the content is summarized in natural language using a summarization LLM of the generative AI system. Based on the matched content from the search results for keywords 134, answer generator 136 may utilize summarization LLM 137 to generate one or more of summaries 138, such as a condensation of key information from the content in a readable, coherent, and concise form. Content summarization may include generating a natural language text as an answer to question 113, such as an answer that would appear in a form that an agent or other human user may provide to the user asking question 113. As such, answer 114 may include a text summarization in natural language and using the natural language skills of summarization LLM 137. Summarization LLM 137 may be requested to generate summaries 138 through one or more LLM prompts, which may include question 113 and the content from the search results, as well as an instruction to summarize the content in response to and/or to answer question 113. Answer 114 may be generated from summaries 138, and may further include links and/or citations to content used to generate the corresponding summary. Answer 114 may thereafter be transmitted to client device 110 and output, which may include provide a refinement option to further submit questions or otherwise revise question 113 for a more specific and detailed search and answer generation.

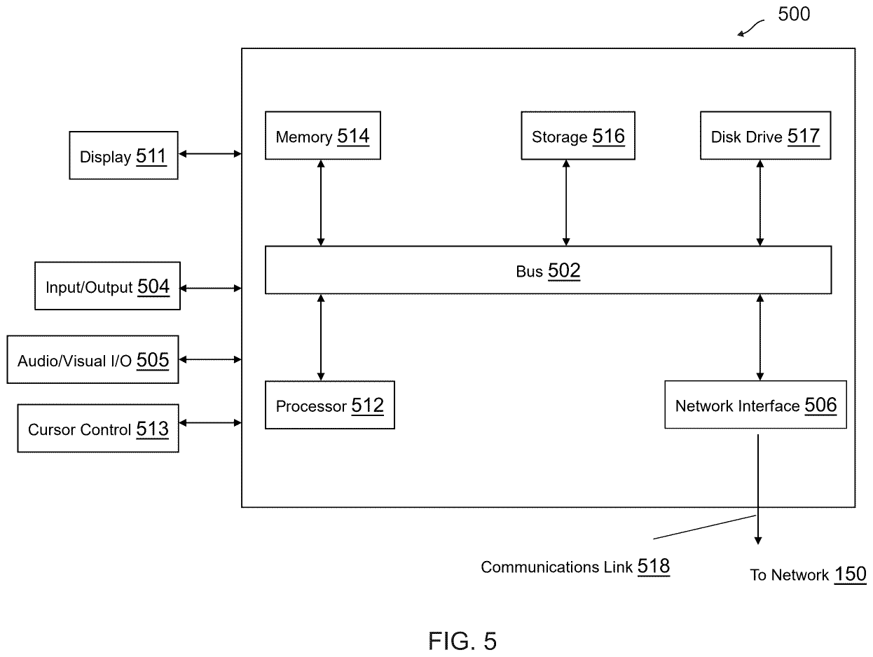

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output component 505 may also be included to allow a user to use voice for inputting information by converting audio signals and/or use video to capture still or video images and provide video input. Audio I/O component 505 may allow the user to hear audio and/or view video. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method comprising:
receiving, via a user interface (UI) of an application, a question based on content from a plurality of distinct data sources;
determining one or more keywords in the question using an embedding large language model (LLM) of a generative artificial intelligence (AI) system, wherein the one or more keywords are determined based on a semantic analysis of embeddings generated from the question by the embedding LLM;
performing a search of the content from the plurality of data sources using the one or more keywords, wherein the search is performed in a plurality of data formats for the plurality of data sources using application programming interface (API) calls to APIs associated with search functions of the plurality of distinct data sources;
identifying one or more matches of the content from the plurality of distinct data sources to the question based on the search, wherein each of the one or more matches comprises data in a corresponding one of the plurality of data formats;
generating an answer to the question based on the one or more matches using a summarization LLM of the generative AI system, wherein the answer comprises a text generated by the summarization LLM from the plurality of data formats; and
outputting, via the UI, the answer to the question.

2. The method of claim 1, wherein the question comprises a natural language question, and wherein the determining the one or more keywords includes predicting an intent and determining a context for the question using a natural language processor (NLP) of the generative AI system.

3. The method of claim 1, wherein the identifying the one or more matches comprises:
converting the question to a first vector using the embedding LLM;
converting search results from the search to one or more second vectors using the embedding LLM;
comparing the first vector to the one or more second vectors based on a vector comparison function; and
determining the one or more matches from the search results based on the vector comparison function and a similarity threshold.

4. The method of claim 3, wherein the determining the one or more keywords comprises:
extracting the one or more keywords from the question using an NLP and one or more third vectors generated for the one or more keywords by the embedding LLM,
wherein the converting the question to the first vector is based, at least in part, on the one or more third vectors generated for the one or more keywords.

5. The method of claim 1, wherein the generating the answer comprises prompting the summarization LLM with an instruction to generate the answer using the one or more matches each in the corresponding one of the plurality of data formats, and wherein the answer summarizes the one or more matches in a text format corresponding to the question.

6. The method of claim 1, further comprising:
receiving feedback associated with the answer; and
updating at least one data retrieval module associated with the performing the search based on the feedback.

7. The method of claim 6, wherein the at least one data retrieval module comprises a retrieval augmented generation (RAG) module, and wherein the updating comprises at least one of:
retraining the RAG module based on the feedback; or
updating one or more data source retrieval criteria of the RAG module based on the feedback.

8. The method of claim 1, wherein the answer comprises a summarization of the one or more matches and the one or more matches ranked based on a relevancy score of each of the one or more matches to the question, and wherein the summarization and the one or more matches ranked are provided via the UI for the answer.

9. The method of claim 1, wherein the plurality of data sources comprises at least one of internal content or internal resources of a service provider, and wherein the plurality of data sources include at least one of an internal chat platform, a service ticketing platform, a code collaboration workspace platform, or computing service documentation.

10. A system comprising:
a non-transitory memory; and
one or more hardware processors coupled to the non-transitory memory and configured to execute instructions to cause the system to:
determine a set of keywords for a question using an embedding large language model (LLM) of a generative artificial intelligence (AI) system, wherein the set of keywords is determined based on a semantic analysis of embeddings generated from the question by the embedding LLM;
perform a search of a plurality of data sources using at least one application programming interface (API) call to an API of search of the plurality of data sources, wherein the API is configured to search a corresponding one of the plurality of data sources for content associated with the set of keywords;
identify the content from the plurality of data sources based on the search, wherein the content comprises data in one of a plurality of data formats for the corresponding one of the plurality of data sources;
generate an answer to the question based on the content using a summarization LLM of the generative AI system, wherein the answer comprises a text generated by the summarization LLM from the plurality of data formats; and
output the answer to the question.

11. The system of claim 10, wherein the answer further comprises one or more links in the text to the content from the plurality of data sources.

12. The system of claim 11, wherein the one or more links are associated with one or more citations in corresponding portions of the text to the content.

13. The system of claim 10, wherein the question comprises a natural language question, and wherein the determining the set of keywords includes predicting an intent and determining a context for the question using a natural language processor (NLP) of the generative AI system.

14. The system of claim 10, wherein the at least one API call to the API utilizes a search function associated with the API and the one of the data formats to search the corresponding one of the plurality of data sources.

15. The system of claim 10, wherein executing the instructions further causes the system to:
receive an additional question that requests one of a refinement of the answer or additional information associated with the content used for the text in the answer, wherein the additional question is associated with the question previously asked;
determine a change to the content based on the additional question; and
update the answer using the summarization LLM and based on the change to the content.

16. The system of claim 15, wherein the additional question is received via a user interface field provided with the answer for the refinement or the additional information.

17. A non-transitory machine-readable medium having stored thereon machine-readable instructions executable to cause a machine to perform operations comprising:
receiving a set of keywords for a question asked by a user via a user interface (UI);
executing a search for one or more matches of content from the plurality of data sources using the set of keywords, wherein the executing the search comprises calling an application programming interface (API) of one of a search engine or a search function associated with each of the plurality of data sources with a request to search a corresponding one of a plurality of data sources based on the set of keywords;
based on search results from executing the search, generating an answer to the question using a summarization large language model (LLM) of a generative artificial intelligence (AI) system, wherein the answer comprises a text generated by the summarization LLM based on the search results; and
providing the answer to the question via the UI.

18. The non-transitory machine-readable medium of claim 17, wherein, prior to the receiving the set of keywords, the operations further comprise:
generating the set of keywords from the question using an embedding LLM of the generative AI system, wherein the set of keywords are determined based on a semantic analysis of embeddings generated from the question by the embedding LLM.

19. The non-transitory machine-readable medium of claim 17, wherein the answer is requested to be provided in natural language as a summarization of the content in place of search results via the UI.

20. The non-transitory machine-readable medium of claim 17, wherein the plurality of data sources are associated with at least one of an internal chat platform, a service ticketing platform, a code collaboration workspace platform, or computing service documentation.
